(19) United States
(12) Patent Application Publication
(10) Pub. No.: US 2008/0002924 A1
(43) Pub. Date: Jan. 3, 2008

(54) Oil-retaining bearing

(75) Inventor: Takayuki Aoi, Nagano-ken (JP)

Correspondence Address: KRATZ, QUINTOS & HANSON, LLP, 1420 K Street, N.W., Suite 400, WASHINGTON, DC, 20005, US

(73) Assignees: SANYO ELECTRIC CO., LTD., Moriguchi-shi (JP); SANYO SEIMITSU CO., LTD., Ueda-shi (JP)

(21) Appl. No.: 11/819,208

(22) Filed: Jun. 26, 2007

(30) Foreign Application Priority Data
Jun. 29, 2006 (JP) 2006-179296

(51) Int. Cl. F16C 17/00

(52) U.S. Cl. 384/279

(57) ABSTRACT

An oil-retaining bearing comprising a center sintered part having a shaft hole, for rotatably supporting a motor shaft, at the outer circumference side of which an auxiliary sintered part is integrally provided, wherein the auxiliary sintered part is provided with a flange-shaped part with a bottom surface designed to lay over the top surface of a baseplate and a first swaging-use ring-shaped projection, formed at the bottom side of that flange-shaped part, designed to fit into the support hole of the baseplate, wherein the first swaging-use ring-shaped projection is formed projecting down downward from a bottom opening position of the shaft hole, whereby even if fixed standing up on the baseplate by swaging, the shaft hole is resistant to deformation.

### CROSS-REFERENCE TO RELATED APPLICATION

This application is based upon and claims priority from Japanese Patent Application No. 2006-179296, filed Jun. 29, 2006, the contents being incorporated herein by reference.

### BACKGROUND OF THE INVENTION

1. Field of the Invention

The present invention relates to an oil-retaining bearing used for a motor unit etc.

2. Description of the Related Art

The bearing system disclosed in Japanese Utility Model Publication (A) No. 6-17356 (FIG. 4) is swaged by fitting an end of an oil-less metal bearing into a support hole of a stator plate.

However, when swaging the end of the oil-less metal bearing, there are the difficulties that the shaft hole of the oil-less metal bearing easily deforms and the precision of the inside diameter of the shaft hole falls, so this is not practical.

### SUMMARY OF THE INVENTION

An object of the present invention is to provide an oil-retaining bearing resistant to deformation of the shaft hole even if fixed standing on a baseplate by swaging.

The present invention provides an oil-retaining bearing comprising a center sintered part having a shaft hole, for rotatably supporting a motor shaft, at the outer circumference side of which an auxiliary sintered part is integrally provided, wherein the auxiliary sintered part is provided with a flange-shaped part with a bottom surface designed to lay over the top surface of a baseplate and a first swaging-use ring-shaped projection, formed at the bottom side of that flange-shaped part, designed to fit into the support hole of the baseplate.

The first swaging-use ring-shaped projection of the oil-retaining bearing is fit into the support hole of the baseplate, then the front end side of the first swaging-use ring-shaped projection is made to plastically deform in the outer circumference direction by swaging to fix the bearing standing up on the baseplate, but the front end side of the first swaging-use ring-shaped projection is positioned at the outer circumference side from the center sintered part having the shaft hole, so even if the front end side of the first swaging-use ring-shaped projection plastically deforms in the outer circumference direction, that strain does not reach the center sintered part, so deformation of the shaft hole can be suppressed. Further, since the first swaging-use ring-shaped projection is positioned at the outer circumference side from the shaft hole, it is possible to suppress the variation in perpendicularity of the motor shaft with respect to the baseplate and possible to improve the yield. Since the oil-retaining bearing is comprised of the center sintered part performing the inherent bearing function and, at the outside, an auxiliary sintered part functioning as a bearing housing formed integrally with it, the number of parts is not increased and the cost can be lowered compared with the case of using a separate bearing housing. Further, it is possible to increase the amount of oil by exactly the amount of oil retained in the pores of the auxiliary sintered part. This contributes to a longer service life.

When the first swaging-use ring-shaped projection is formed projecting further down from the bottom opening position of the shaft hole, the swaging location is offset from the shaft hole in the axial direction, so deformation of the shaft hole can be further suppressed.

Further, the auxiliary sintered part is preferably provided with a second swaging-use ring-shaped projection formed integrally with the top side of the flange-shaped part and designed to fit in the center hole of the magnetic core. The bottom surface side of the magnetic core is designed to be laid over the top surface of the flange-shaped part and that center hole is fit with the second swaging-use ring-shaped projection, so the front end side of the second swaging-use ring-shaped projection is fixed by plastic deformation at the outer circumference direction by swaging, but the front end side of the second swaging-use ring-shaped projection is positioned at the outer circumference side from the center sintered part having the shaft hole, so even if the front end side of the second swaging-use ring-shaped projection plastically deforms to the outer circumference direction, that strain will not reach the center sintered part and deformation of the shaft hole can be suppressed.

Here, as the structure for preventing the motor shaft from projecting out to the rear surface side of the baseplate, the auxiliary sintered part is preferably provided at the bottom side of the flange-shaped part with a third swaging-use ring-shaped projection formed integrally at the inner circumference side from the first swaging projection and into which the outer circumference of a thrust support member for receiving the end of the motor shaft is designed to be fit. The thrust support member is fit from the rear surface side of the base plate into the third swaging-use ring-shaped projection and the front end side of the third swaging-use ring-shaped projection is made to plastically deform in the inner circumference direction by swaging to fix it in place, but the front end side of the third swaging-use ring-shaped projection is positioned at the outer circumference side from the center sintered part having the shaft hole, so even if the front end side of the second swaging-use ring-shaped projection plastically deforms in the inner circumference direction, that strain will not reach the center sintered part and deformation of the shaft hole can be suppressed. Note that the thrust support member may also be a support member holding the thrust plate for receiving the end of the motor shaft.

When the third swaging-use ring-shaped projection is formed projecting further downward from the bottom opening position of the shaft hole, the swaging location is offset from the shaft hole in the axial direction, so deformation of the shaft hole can be further suppressed.

Note that the above-mentioned oil-retaining bearing is suitably used for a brushless motor or other motor unit.

That oil-retaining bearing according to the present invention is comprised of the center sintered part performing the inherent bearing function and, at the outside, an auxiliary sintered part functioning as a bearing housing formed integrally with it. That auxiliary sintered part is provided with a swaging-use ring-shaped projection, so even if fixed standing up on the baseplate by swaging, the shaft hole is resistant to deformation.

### BRIEF DESCRIPTION OF THE DRAWINGS

These and other objects and features of the present invention will become clearer from the following description of the preferred embodiments given with reference to the attached drawings, wherein:

FIG. 1 is a longitudinal cross-sectional view showing a disk motor using an oil-retaining bearing according to an embodiment of the present invention;

FIG. 2A is a perspective view showing the state of the oil-retaining bearing as seen from above, while FIG. 2B is a perspective view showing the state of the oil-retaining bearing as seen from below; and

FIG. 3 is a longitudinal cross-sectional view showing that oil-retaining bearing.

### DESCRIPTION OF THE PREFERRED EMBODIMENTS

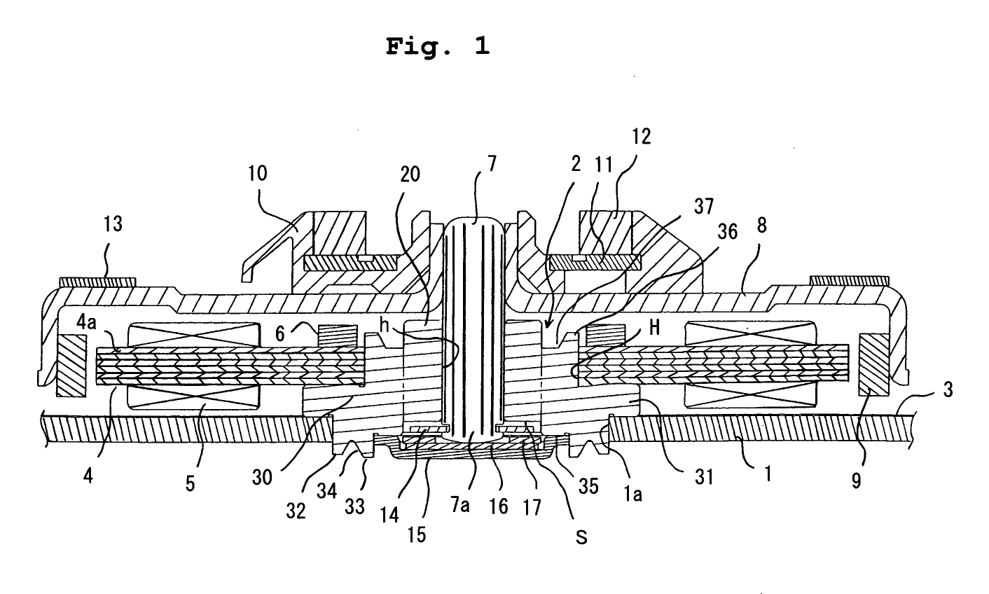

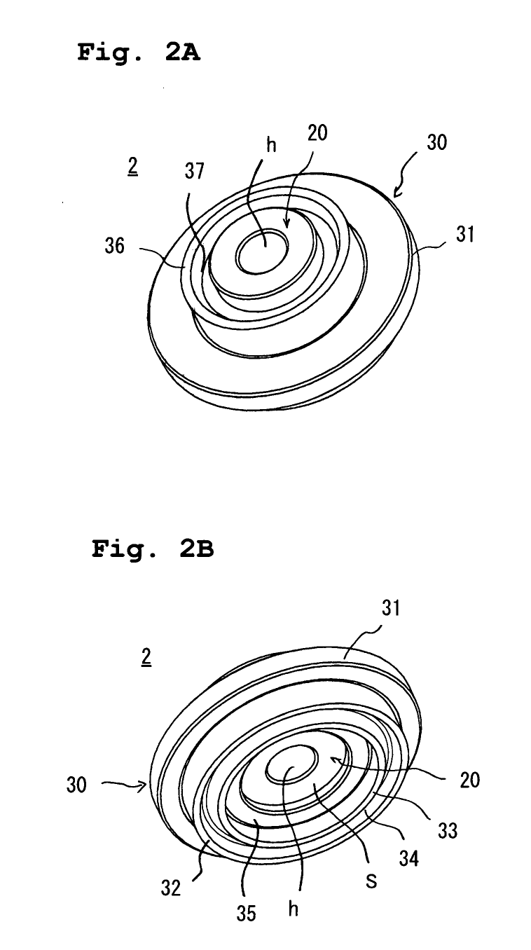

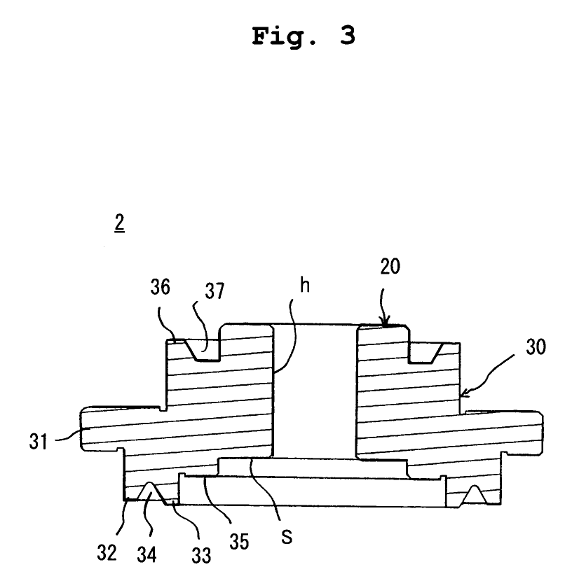

Next, embodiments of the present invention will be explained based on the attached drawings. FIG. 1 is a longitudinal cross-sectional view showing a disk motor using an oil-retaining bearing according to an embodiment of the present invention, FIG. 2A is a perspective view showing the state of the oil-retaining bearing as seen from above, while FIG. 2B is a perspective view showing the state of the oil-retaining bearing as seen from below; and FIG. 3 is a longitudinal cross-sectional view showing that oil-retaining bearing.

The disk motor of this embodiment is a small brushless motor. Its stator has a metal baseplate (stator plate) 1, an oil-retaining bearing 2 supported by a support hole la of that baseplate 1 in a standing posture, a flexible printed circuit board 3 for drive current control laid over the top surface of the baseplate 1, a magnetic core 4 comprised of a plurality of magnetic plates 4a stacked together and supported at a top peripheral step surface of the oil-retaining bearing 2 in a parallel posture with the baseplate 1, a coil winding 5 wound around that magnetic core 4, and a magnet 6 provided at the top of the magnetic core 4 and pulling in the rotor yoke 8.

Further, the rotor has a motor shaft 7 inserted into a shaft hole of the oil-retaining bearing 2, a rotor yoke 8 fit over the part of the motor shaft 7 projecting out from the oil-retaining bearing 2, a ring-shaped magnet 9 provided at the inner circumference of the rotor yoke 8, a centering member 10 for engaging with a disk (not shown) in a centering manner, a ring-shaped back yoke 11 provided in the ring-shaped groove of the centering member 10, a clamp magnet 12 for clamping the disk by the centering member 10, and a cushion material 13 adhered to the outer circumference side of the rotor yoke 8.

A lock ring 14 is fit over the bottom end 7a of the motor shaft 7. That bottom end 7a is locked at the thrust plate 16 on the support cap 15. A washer 17 acting as a spacer is sandwiched between the lock ring 14 and the thrust plate 16.

The oil-retaining bearing 2 of this embodiment is comprised of metal powder shaped and sintered to form a sintered body which is then impregnated with oil. As shown by the range of the two-dot broken line of FIG. 1, it has a center sintered part 20 having a shaft hole h for rotatably supporting the motor shaft 7 and corresponding to a main tubular bearing part and an auxiliary sintered part 30 integrally provided at the outer circumference side of that center sintered part 20.

The auxiliary sintered part 30 is comprised of a flange-shaped part 31 with a bottom surface designed to be laid over the top surface side of the baseplate 1, a first swaging-use ring-shaped projection 32 formed integrally with the bottom side of that flange-shaped part 31 and designed to be fit in a support hole la of the baseplate 1, and a third swaging-use ring-shaped projection 33 integrally formed at the bottom side of the flange-shaped part 31 at the inner circumference side from the first swaging projection 32 and designed so that the outer circumference of the support cap 15 can be fit with it. A V-shaped first ring-shaped groove 34 is formed between the first swaging-use ring-shaped projection 32 and third swaging-use ring-shaped projection 33. The inner circumference side of the third swaging-use ring-shaped projection 33 forms a ring-shaped receiving surface 35 over which the outer circumference side of the support cap 15 is laid. That ring-shaped receiving surface 35 is positioned in the middle of the sheet thickness of the baseplate 1. For that reason, the level of attachment of the first swaging-use ring-shaped projection 32 and the level of attachment of the third swaging-use ring-shaped projection 33 differ. The first swaging-use ring-shaped projection 32 and the third swaging-use ring-shaped projection 33 both project further down from the bottom opening surface S and are offset downward from the bottom opening surface S of the shaft hole h. The bottom surface of the flange-shaped part 31 and the outer circumference of the first swaging-use ring-shaped projection 32 form the bottom peripheral step surface for engagement with the support hole la of the baseplate 1.

Further, the auxiliary sintered part 30 is provided with a second swaging-use ring-shaped projection 36, formed integrally with the top side of the flange-shaped part 31 and designed to fit into the center hole H of the magnetic core 4, separated from the center sintered part 20 by the second ring-shaped groove 37. The top surface of the flange-shaped part 31 and the outer circumference of the second swaging-use ring-shaped projection 36 form a top peripheral step surface for engagement with the center hole H of the magnetic core.

The oil-retaining bearing 2 is fixed standing up on the baseplate 1 by inserting the first swaging-use ring-shaped projection 32 into the support hole la of the baseplate 1, then making the front end side of the first swaging-use ring-shaped projection 32 plastically deform in the outer circumference direction by swaging. The front end side of the first swaging-use ring-shaped projection 32 is positioned at the outer circumference side from the center sintered part 20 having a shaft hole h, so even if the front end side of the first swaging-use ring-shaped projection 32 plastically deforms in the outer circumference direction, that strain will not reach the center sintered part 20 and deformation of the shaft hole h can be suppressed. Further, the first swaging-use ring-shaped projection 32 is positioned at the outer circumference side from the shaft hole h, so it is possible to suppress the variation in perpendicularity of the motor shaft 7 with respect to the baseplate 1 and possible to improve the yield. That oil-retaining bearing 2 is comprised of the center sintered part 20 performing the inherent bearing function and, at the outside, an auxiliary sintered part 30 functioning as a bearing housing formed integrally with it, so the number of parts is not increased and the cost can be lowered compared with the case of using a separate bearing housing. Further, it is possible to increase the amount of oil by exactly the amount of oil retained in the pores of the auxiliary sintered part 30. This contributes to longer service life. Further, the first swaging-use ring-shaped projection 32 projects further downward from the bottom opening surface S of the shaft hole h and the swaging location is offset in the axial direction from the shaft hole h, so deformation of the shaft hole h is further suppressed.

The magnetic core 4 is fixed by fitting the center hole H over the second swaging-use ring-shaped projection 36 so as to lay over the top surface of the flange-shaped part 31, then making the front end side of the second swaging-use ring-shaped projection 36 plastically deform in the outer circumference direction by swaging. The front end side of the second swaging-use ring-shaped projection 36 is positioned at the outer circumference side from the center sintered part 20 having a shaft hole h, so even if the front end side of the second swaging-use ring-shaped projection 36 plastically deforms in the outer circumference direction, that strain does not reach the center sintered part 20 and deformation of the shaft hole h can be suppressed.

The support cap member 15 carrying the washer 17 and the thrust plate 16 is fit from the back surface side of the baseplate 1 in the third swaging-use ring-shaped projection 33, then is fixed by making the front end side of the third swaging-use ring-shaped projection 33 plastically deform in the inner circumference direction by swaging. The front end side of the third swaging-use ring-shaped projection 33 is positioned at the outer circumference side from the center sintered part 20 having the shaft hole h, so even if the front end side of the third swaging-use ring-shaped projection 33 plastically deforms in the inner circumference direction, that strain does not reach the center sintered part 20 and deformation of the shaft hole h can be suppressed. Further, the third swaging-use ring-shaped projection 33 projects down further from the bottom opening surface S of the shaft hole h and the swaging location is offset from the shaft hole h in the axial direction, so deformation of the shaft hole h can be further suppressed.

While the invention has been described with reference to specific embodiments chosen for purpose of illustration, it should be apparent that numerous modifications could be made thereto by those skilled in the art without departing from the basic concept and scope of the invention.

1. An oil-retaining bearing comprising a center sintered part having a shaft hole, for rotatably supporting a motor shaft, at the outer circumference side of which an auxiliary sintered part is integrally provided, wherein
said auxiliary sintered part is provided with a flange-shaped part with a bottom surface designed to lay over the top surface of a baseplate and
a first swaging-use ring-shaped projection, formed at the bottom side of that flange-shaped part, designed to fit into said support hole of the baseplate.

2. An oil-retaining bearing as set forth in claim 1, wherein said first swaging-use ring-shaped projection is formed projecting down downward from a bottom opening position of said shaft hole.

3. An oil-retaining bearing as set forth in claim 1 wherein said auxiliary sintered part is provided with a second swaging-use ring-shaped projection, formed at the top side of that flange-shaped part, designed to fit into a center hole of the magnetic core.

4. An oil-retaining bearing as set forth in claim 1, wherein said auxiliary sintered part is provided with a third swaging-use ring-shaped projection integrally formed at the bottom side of said flange-shaped part at the inner circumference side from said first swaging projection and into which the outer circumference of the thrust support member for receiving said end of the motor shaft is fit.

5. An oil-retaining bearing as set forth in claim 4, wherein said third swaging-use ring-shaped projection is formed projecting further downward than a bottom opening position of said shaft hole.

6. A motor unit using an oil-retaining bearing as set forth in claim 1.
